(19) United States
(12) Patent Application Publication
(10) Pub. No.: US 2023/0317369 A1
(43) Pub. Date: Oct. 5, 2023

(54) PRODUCTION OF MAGNETIC MATERIALS

(71) Applicant: US Metals Refining Group, Inc., Centennial, CO (US)

(72) Inventor: Henry W. Kasaini, Centennial, CO (US)

(21) Appl. No.: 18/007,688

(22) PCT Filed: Jun. 1, 2021
(86) PCT No.: PCT/US2021/035313

§ 371 Date: Dec. 1, 2022

Related U.S. Application Data
(60) Provisional application No. 62/704,883, filed on Jun. 1, 2020.

(51) Int. Cl. H01F 41/02; H01F 7/02; H01F 1/055; B22F 9/20; B22F 3/16; B22F 5/10; C22C 1/04; C22C 19/07; C22C 30/02; C22C 33/02; C22C 38/16; C22C 38/10; C22C 38/06; C22C 38/04; C22C 38/00

(52) U.S. Cl. CPC H01F 41/0253; H01F 7/0205; H01F 1/0557; B22F 9/20; B22F 3/16; B22F 5/106; C22C 1/0441; C22C 19/07; C22C 30/02; C22C 33/0235; C22C 38/16; C22C 38/105; C22C 38/06; C22C 38/04; C22C 38/005; C22C 38/002; C22C 38/001; B22F 2998/10; B22F 2201/02; B22F 2201/013; C22C 2202/02; B22F 2301/355; B22F 2999/00

(57) ABSTRACT

Methods for the production of magnetic powders, compacted magnetic bodies and sintered magnetic bodies. The methods include the use of metal carboxylate precursor compounds such as metal oxalates. The precursor compounds are heated under pressure to form metal alloy particles which can be directly formed into compacted magnetic bodies or can be further refined by using a reductant at elevated temperatures and pressures. The sintered magnetic bodies may have strong magnetic properties even if produced in the absence of a strong magnetic field.

### CROSS-REFERENCE TO RELATED APPLICATIONS

This application claims the priority benefit of U.S. Provisional Application No. 62/704,883 by Kasaini and filed on Jun. 1, 2020, which is incorporated herein by reference in its entirety.

### FIELD

This invention relates to the field of magnetic alloy materials, and particularly to magnetic alloy powders and magnetic bodies and methods for the production of magnetic powders and bodies from metal salts such as carboxylate salts.

### DESCRIPTION OF THE DRAWINGS

FIG. 1 illustrates an exemplary heating profile for the production of a magnetic alloy powder and a sintered magnetic body in accordance with an embodiment of the present disclosure.

FIG. 2 illustrates an exemplary heating profile for the production of a sintered magnetic body in accordance with an embodiment of the present disclosure.

FIG. 3 illustrates a scanning electron microscope (SEM) photomicrograph of an intermediate magnetic alloy powder according to an embodiment of the present disclosure.

### DETAILED DESCRIPTION

The present disclosure is directed to methods for the manufacture of magnetic powders from metal carboxylate compounds, compacted magnetic bodies (e.g., “green” bodies) and to methods for the manufacture of sintered magnetic bodies, i.e., formed from the magnetic powders and/or compacted magnetic bodies. The present disclosure is also related to compacted magnetic bodies and sintered magnetic bodies, e.g., magnetic materials formed by the methods disclosed herein. The methods enable the rapid and economical manufacture of a variety of magnetic materials including, but not limited to, rare earth magnets such as neodymium ferroboron (e.g., NdFeB), samarium cobalt (e.g., SmCo), alnico-type magnets (e.g., AlNiCo) and magnetic anode materials such as REE-NiCuCo (where REE is a rare earth element) or Ce—La—Nd—Pr—Y—Ni—Co—Fe for example. As used herein, the term “magnetic material” refers to a material (e.g., an alloy) that produces a magnetic field. As is noted below, although this disclosure relates primarily to magnetic materials, the methods may be applicable to certain non-magnetic alloys such as Ti—Al—V.

In a first embodiment, a method for producing magnetic metal powders is disclosed. Broadly characterized, the method includes the decomposition of metal carboxylate compounds such as iron carboxylates, neodymium carboxylates, praseodymium carboxylates and cobalt carboxylates in a reducing atmosphere at elevated and pressure to form of iron-rich alloy crystals (e.g., NdFe, NdPrFe, NdFeCo) with traces of oxidized alloys such as NdFeO₃ or NdPrFeO₃. A subsequent refining step is utilized to eliminate the traces of oxygen, which may include the addition of an alkaline earth metal or alkaline earth metal hydride, e.g., Ca or CaH₂. The alkaline earth metal hydride decomposes and the alkaline earth metal melts at a temperature below the melting point of the metal alloy powder and reacts with oxygen to form a non-magnetic by-product (e.g., CaO). The CaO by-product may be separated from the magnetic alloy powder (e.g., NdFeB, NdPrFeB, NdFeCo and/or NdFeCoB).

In a second embodiment, a method for producing a compacted magnetic body is disclosed. Broadly characterized, the method includes providing a precursor powder to a mold (e.g., a crucible) where the precursor powder includes particulates of at least one metallic compound, e.g., a metallic salt such as a metal carboxylate salt. When provided to the mold, the precursor powder may have a very small mass median diameter (D50) of not greater than about 100 μm. The precursor powder disposed within the mold is heated to a precursor conversion temperature that is sufficient to convert the metallic compound to a metal, i.e., to a powder comprising particulates of the metal. During at least a portion of the heating step, the precursor powder is maintained under a gas pressure of at least about 2 bar (0.2 MPa). It has been found that the compacted magnetic body formed in accordance with the foregoing method may advantageously have an anisotropic magnetic alignment (e.g., polarity), even in the absence of an applied magnetic field during the heating step. This method also utilizes a precursor powder comprised of individual metallic compound particulates such as metallic salts, which are converted to individual elements and elemental alloy particulates and subsequently compacted (e.g., in the same process) by using a gas to form the well aligned compacted magnetic material. In traditional methods for manufacturing magnetic bodies, solid (e.g., bulk) metal alloys, rather than individual metallic elements, are pre-formed by melting individual metal ingots in a furnace and casting the molten metal into metal strips, which serve as the precursor material for forming metal alloy powders. In this method, single metal alloy particulates are produced by pulverizing the cast strips into a powder using a mechanical device such as a crusher and/or jet mill. Such metal powders carry magnetically mis-aligned particulates and therefore a strong external magnetic field is applied to re-align the powder particulates as the particulates undergo mechanical compaction into a cohesive magnetic body.

In another embodiment, high density sintered magnetic bodies are produced from either the magnetic powders of the first embodiment or the compacted bodies of the second embodiment.

Thus, broadly characterized, the production of compacted magnetic bodies and/or sintered magnetic bodies is preceded by two process steps, namely the decomposition of precursor powders (e.g., metal oxalate precursors) and the refining of the metal powders to remove all traces of carbon and oxygen, which facilitates the coalescence of pure metal alloy crystals at elevated temperature and pressure. This may result in uniform crystalline alloy grains having well defined crystals, and a resulting high anisotropy and polarity in the magnetic body. In the case of NdFeB alloys, for example, the powders contain the iron-rich phase (NdFeB) and neodymium-rich phase (NdFeB).

While not wishing to be bound by any particular theory, it is believed that the magnetic alignment in the compacted body at elevated temperature and gas pressure arises due to the presence of an induced energy gradient within the multi-element micro-powder crystals as a result of differing heat capacities and spin of individual elemental metal particulates in the mixed alloys, i.e., due to the different energy levels and a heterogeneous fusion of the individual particles at elemental scale into metal alloy crystals. Further, the production of compacted magnetic bodies and sintered magnetic bodies is facilitated by the decomposition of precursor powders (e.g., metal oxalate precursors), which facilitates the coalescence of metal alloy crystals at elevated temperature and pressure. This may result in uniform crystalline alloy grains having well defined crystals, and a resulting high anisotropy and polarity in the magnetic body.

As is noted above, the precursor powder includes particulates of at least one metallic compound (e.g., a first metallic compound). As used herein, the term “metallic compound” refers to a compound that includes at least one metal element and at least one non-metallic element or group of elements chemically bonded to the metal, e.g., as opposed to a single metal or metal alloy. Metallic compounds include, for example, metal salts and metal oxides. In one embodiment, the precursor powder includes metal carboxylate compounds, e.g., a metal compound comprising the metal, carbon, oxygen and possibly hydrogen and/or nitrogen. In one characterization, the metallic compound is a metal oxalate compound. Metal oxalates are salts of oxalic acid with a dianion of the form C₂O₄²⁻, e.g., Me₂C₂O₄, MeC₂O₄, Me₂(C₂O₄)₃, etc. where Me represents the metal. Metal oxalates also include, for example, ammonium metal oxalate compounds. The following description refers primarily to the use of metal oxalate compounds, although other metal carboxylate compounds may be substituted for the metal oxalate compounds.

Useful magnetic materials (e.g., metal alloys) comprise several elements, e.g., two, three or more elements. For many useful magnetic materials, at least one of the elements is a rare earth element, such as in a NdFeB, SmCo or an REE-NiCoCu magnetic material. In this regard, the precursor powder may include particulates of at least one rare earth oxalate compound. In one characterization, the precursor powder includes particulates of at least two rare earth oxalate compounds, i.e., two different oxalate compounds of two different rare earth elements.

In one embodiment, the precursor powder includes at least particulate iron oxalate and particulate neodymium oxalate. In one characterization, this precursor powder further comprises boron, e.g., in the form of metallic boron to form a NdFeB magnetic material. The precursor powder may further include praseodymium oxalate, e.g., to form a NdPrFeB magnetic material.

In another embodiment, the precursor powder includes particulates of samarium oxalate. The precursor powder may further include particulates of metallic cobalt or a cobalt compound such as cobalt oxalate, i.e., to form a SmCo magnetic material. Precursor compounds for SmCo may include additional and desirable traces of copper oxalate, iron oxalates, zirconium metal and/or hafnium metal.

In another embodiment, the precursor powder may include particulates of ammonium niobate oxalate, ammonium vanadyl oxalate and/or ammonium titanyl oxalate, e.g., where niobium, vanadium and titanium are desirable trace elements in the magnetic body.

The methods of the present disclosure are also applicable to magnetic materials that do not include rare earth elements (REEs), such as iron-based magnets. Thus, in one embodiment, the precursor powder comprises particulates of iron oxalate. For example, the precursor powder may comprise particulates of iron oxalate combined with particulates of cobalt oxalate, nickel oxalate and particulates of metallic aluminum to form an AlNiCo-type magnetic material. In this regard, the precursor powder may also include particulates of titanium oxalate (e.g., ammonium titanium oxalate) and particulates of copper oxalate.

As noted above, the precursor powder may include metal oxalate compounds as a precursor to the metal in the compacted magnetic body. However, as is apparent from the description above, some metals that are desired in the compacted magnetic material may be provided as particulates of the metal (e.g., having a valence of zero) in the precursor powder. For example, when the desirable metal is required in low concentrations (e.g., less than about 0.2 wt. %), it may be useful to supply the desirable metal to the precursor powder as particulates of the metal e.g., as substantially pure metal particulates. Examples include, but are not limited to, particulates of aluminum, boron, zirconium and/or hafnium in NdFeB, SmCo and/or AlNiCo magnetic materials. The precursor powder may also include one or more metallic compounds that are very small diameter non-oxalate metal compounds, such as a metal oxide. One example of a useful metal oxide is gallium oxide. In any event, it is generally preferred that the precursor powder comprises a significant amount of metal oxalate compounds, such as at least about 80 wt. % metal oxalate compounds, at least about 90 wt. % metal oxalate compounds, at least about 95% metal oxalate compounds or even at least about 98% metal oxalate compounds.

It is also generally preferable that the precursor powder have a relatively low free carbon content, e.g., not greater than about 0.1 wt. % free carbon. However, in some embodiments it may be desirable for the precursor powder to comprise a small amount of free carbon, e.g., by adding a small amount of free carbon (e.g., graphite) to the precursor powder. A small amount of carbon may be advantageous for the sequestration of residual oxygen at elevated temperatures during the conversion of precursor powder to metallic powder. In this regard, the precursor powder may include up to about 2.5 wt. % free carbon, such as up to about 1.5 wt. % free carbon, or even up to about 0.5 wt. % free carbon. However, it is typically desirable that any carbon present in the precursor powder reacts during the heating step such that the metallic powder and the compacted metal body have a free carbon content of not greater than about 0.5 wt. %, not greater than 0.25 wt. %, or even not greater than about 0.1 wt. % for example. A graphite mold (crucible) may also be used to assist in the removal of residual oxygen from the magnetic material.

As noted above, the mean average particulate size of the precursor powder that is provided to the furnace for heating may advantageously be not greater than about 100 μm. It is believed that a relatively small particulate size is desirable to achieve an alignment of the metal crystals in the compacted magnetic body, discussed below. In certain characterizations, the precursor powder has a mean average particulate size of not greater than about 50 μm, such as not greater than about 40 μm, such as not greater than about 25 μm, such as not greater than about 15 μm, not greater than about 12 μm, or even not greater than about 10 μm. It is believed that improved magnetic properties may be achieved when the precursor powder has a mean average particulate size of not greater than about 7 μm, such as not greater than about 5 μm. Although it is not believed that there is any particular lower limit on the mean average particulate size, as a practical matter the mean average particulate size will at least about 0.25 μm, such as at least about 0.1 μm, or even at least about 0.5 μm. To obtain a precursor powder having the foregoing desirable particle size, it may be useful to grind the precursor powder to reduce the particle size.

In most cases, particulate metal oxalate compounds are hydrated metal oxalate compounds that include water of hydration, e.g., MeC₂O₄·nH₂O, where n can range from 1 to 12, for example. Table I illustrates the concentrations in weight percent for typical hydrated and anhydrous metal oxalate compounds.

TABLE I

| | Hydrated Metal Oxalates | | | Anhydrous Metal Oxalates | |
|---|---|---|---|---|---|
| | Meₓ(C₂O₄)_{y}•nH₂O | | | Meₓ(C₂O₄)_{y} | |
| | | | nH₂O | Meₓ | (C₂O₄)_{y} |
| Metal Oxalate | Meₓ (wt. %) | (C₂O₄)_{y} (wt. %) | (wt. %) | (wt. %) | (wt. %) |
| La₂(C₂O₄)₃•nH₂O | 38.48 | 36.57 | 24.95 | 51.27 | 48.73 |
| Nd₂(C₂O₄)₃•nH₂O | 39.37 | 36.04 | 24.59 | 52.21 | 47.79 |
| Pr₂(C₂O₄)₃•nH₂O | 38.82 | 36.37 | 24.81 | 51.63 | 48.37 |
| Sm₂(C₂O₄)₃•nH₂O | 40.37 | 35.45 | 24.18 | 53.25 | 46.75 |
| Dy₂(C₂O₄)₃•nH₂O | 42.25 | 34.33 | 23.42 | 55.17 | 44.83 |
| Tb₂(C₂O₄)₃•nH₂O | 41.71 | 34.65 | 23.64 | 54.62 | 45.38 |
| Y₂(C₂O₄)₃•nH₂O | 28.59 | 42.45 | 28.96 | 40.24 | 59.76 |
| Sc₂(C₂O₄)₃•nH₂O | 18.73 | 55.00 | 30.02 | 26.76 | 78.60 |
| Fe₂(C₂O₄)₃•nH₂O | 31.04 | 48.93 | 20.03 | 38.82 | 61.18 |
| CoC₂O₄•nH₂O | 32.21 | 48.10 | 19.69 | 40.10 | 59.90 |
| NiC₂O₄•nH₂O | 32.12 | 48.17 | 19.72 | 40.00 | 59.99 |
| NbC₂O₄•nH₂O | 24.71 | 58.52 | 16.77 | 29.69 | 70.31 |
| Li₂(C₂O₄)•nH₂O | 10.06 | 63.81 | 26.12 | 13.62 | 86.38 |
| NH₄NbO₂(C₂O₄)₂• | 28.94 | 65.44* | 5.61 | 30.66 | 69.34 |
| nH₂O | | | | | |
| NH₄TiO₂(C₂O₄)₂• | 16.28 | 77.59* | 6.13 | 17.34 | 82.66 |
| nH₂O | | | | | |

*(NH)ₓ(C₂O₄)_{y}

As can be seen in Table I, hydrated metal oxalate compounds typically include from about 5 wt. % to about 30 wt. % water of hydration, with the ammonium oxalate compounds containing the smaller concentrations. According to the present disclosure, it is desirable to dehydrate the particulates of the hydrated metal oxalate compounds without oxidizing the metal elements, i.e., to remove the water of hydration and form particulates of an anhydrous metal oxalate compound and water vapor, before conversion of the anhydrous particulate metal oxalate compound to the particulate metal. In one embodiment, particulates of hydrated metal oxalate compound are dehydrated by heating the precursor powder to an elevated dehydration temperature, such as to a temperature of at least about 180° C., such as at least about 200° C., such as at least about 220° C., such as at least about 240° C., or even at least about 260° C. Such dehydration temperatures are typically sufficient remove the water of hydration and reduce the size of the metal oxalate compound particulates, e.g., as a result of the water loss. The hydrated particulate metal oxalate compounds should not be subjected to conditions of excess heat and/or pressure during dehydration that would lead to substantial decomposition of the metal oxalate (e.g., to the metal) before substantially all of the water of hydration has been removed from the particulates. For most metal oxalate compounds, the temperature during the heating step to remove the water of hydration should not be greater than about 320° C., such as not greater than about 300° C., such as not greater than about 280° C. As with the minimum temperatures for dehydration of the hydrated particulate metal oxalate compounds described above, the maximum desirable temperature for dehydration will be influenced by the pressure under which the dehydration step is carried out (e.g., the dehydration pressure). In one characterization, the step of dehydrating the hydrated particulate metal oxalate compounds is carried out at a dehydration temperature in the range of from about 230° C. to about 300° C., such as from about 240° C. to about 280° C. In another characterization, the dehydration step is carried out under a pressure of not greater than about 2.5 bar, e.g., from atmospheric pressure (about 1 bar) to about 2.5 bar.

It is also desirable to separate the water vapor released from the hydrated particulate metal oxalate compounds during the dehydrating step to prevent the water vapor from recombining with the metal oxalate compound. In this regard, the precursor powder may be placed in a crucible (e.g., a mold) that is exposed to the atmosphere to permit the water vapor to escape. A sweep gas (e.g., a dehydration gas) may be moved past (e.g., through) the metal oxalate compound particulates to separate the water vapor from the particulates and carry the vapor out of the furnace. The dehydration gas may comprise an inert gas, e.g., nitrogen, argon, helium etc., and in one characterization the dehydration gas comprises nitrogen, and may consist essentially of nitrogen. Inert gases such as argon may also be included in the dehydration gas. The dehydration gas may also comprise relatively small concentrations of hydrogen, such as not greater than about 12% hydrogen, and in one embodiment includes up to about 6% hydrogen. It is desirable that the sweep gas have a low oxygen content, and in one embodiment the sweep gas comprises not greater than about 1% oxygen, such as not greater than about 0.5% oxygen, such as not greater than about 0.1% oxygen, or even not greater than about 0.05% oxygen.

The step of dehydrating the hydrated particulate metal oxalate compounds should be carried out for a time to remove substantially all the water of hydration from the hydrated metal oxalate compound particulates. In one embodiment, the dehydration step removes at least about 95% of the water of hydration from the hydrated metal oxalate compound particulates, such as at least about 98% of the water of hydration, such as at least about 99% of the water of hydration, at least about 99.5% of the water of hydration, or even at least about 99.9% of the water of hydration from the hydrated metal oxalate compounds. The amount of time that is required to heat the precursor powder at the dehydration temperature to achieve such removal of water is dependent on a number of factors and may be from about 6 hours to about 12 hours.

Alternatively, the metal oxalate compound may be provided as an anhydrous metal oxalate compound, i.e., a metal oxalate compound that includes substantially no water of hydration (i.e., water of crystallization). In this case, the anhydrous particulate metal oxalate compounds may be directly heated under a decomposition gas to decompose the metal oxalate compound to a metal, e.g., without a dehydration step.

In either case, the precursor powder including particulates of at least one anhydrous metal oxalate compound is heated to a precursor conversion temperature within a mold or a crucible to convert the metal compounds to a metallic form, e.g. to a metal alloy. In one characterization, the mold or crucible is formed from alumina, e.g., 99.9% pure alumina. In another characterization, the mold or crucible is formed from another ceramic material, e.g., mullite (3Al₂O₃·2SiO₂). If the precursor powder includes hydrated compounds, as is discussed above, the heating step may be carried out while the precursor powder is in the same mold or crucible as was used during the dehydration step, e.g., with no substantial cooling of the precursor powder before moving from a dehydrating step to the conversion step.

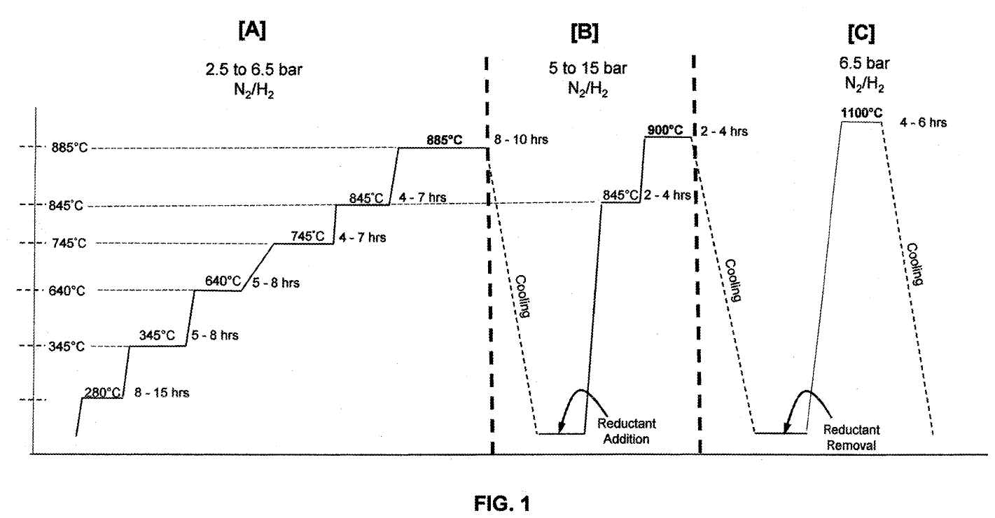

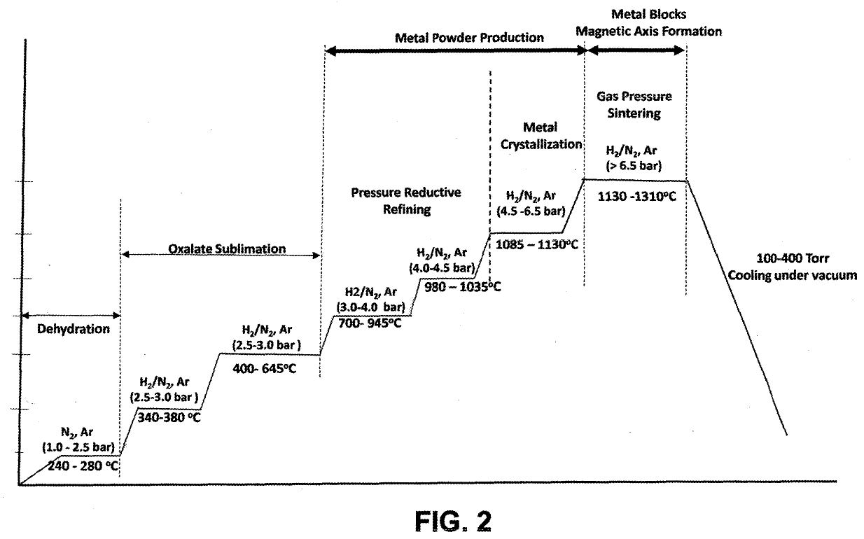

The desired conversion temperature for the precursor powder, e.g., to form the intermediate powder, will depend upon the chemical composition of the precursor powder. In one characterization, the heating step includes heating the precursor powder to a final precursor conversion temperature of at least about 800° C., such as at least about 840° C., or even at least about 880° C. Typically, the final precursor conversion temperature will be not greater than about 1000° C., such as not greater than about 900° C. It will be appreciated that the precursor powder may be heated stepwise to the final conversion temperature, e.g., heating and holding the precursor powder at various temperatures on the way to the final conversion temperature, as is discussed below with respect to FIG. 1 and FIG. 2. The conversion of the precursor powder to the intermediate metallic magnetic powder may be carried out under a non-oxidizing gas composition, e.g., a gas composition containing little to no oxygen. In one characterization, the non-oxidizing gas composition includes at least about 95% of nitrogen and hydrogen combined, such as at least about 98% of nitrogen and hydrogen combined. Other components of the non-oxidizing gas composition may include carbon monoxide, for example.

Thereafter, the intermediate metallic powder, including trace metal oxides, is subjected to a refining step to remove the trace metal oxides and form a crystalline magnetic powder of high purity. The refining step may include increasing the temperature and/or pressure after the conversion step, e.g., without cooling of the intermediate powder. Alternatively, the intermediate powder including trace metal oxides may be cooled before being refined in a refining step. In any event, the refining step includes heating the intermediate powder to an elevated temperature (e.g., greater than the temperature of the conversion step) and the application of a pressure, i.e., greater than ambient pressure.

In one embodiment, a reductant is utilized to facilitate the conversion of the precursor powder to the high purity metal in the refining step. The use of a reductant may be particularly advantageous when an intermediate metal powder is formed for subsequent sintering into a magnetic body. In one implementation, the reductant comprises a carbon and nitrogen-rich organic reducing compound that facilitates the refinement of metal powders formed from metal compounds, e.g., the refinement of metal powders formed in accordance with the foregoing embodiments, e.g., during the refinement step. The organic reductant is selected to lower the oxygen-content of the final powder and hence improve the purity of the final metal powder. For example, the organic reductant may be a methyl complex, such as a methyl nitro oxyl compound. In one characterization, the organic reductant comprises hexamethylenetetramine (HMTA, sometimes referred to as methenamine). The organic reductant provides excess carbon and nitrogen atoms to react with residual oxygen atoms on the metal powder surface at relatively low temperatures, i.e., to “polish” the fine metal powder by scavenging the oxygen.

The organic reductant (e.g., HMTA) may be added at any point during the production of the fine metal powder from a metal compound. For example, the organic reductant may be added to the precursor powder and/or to the intermediate metal powder prior to and/or during the refinement step. In one characterization, the organic reductant is added to the precursor powder (e.g., precursor to the metal) in an amount of at least about 0.05 wt. %, such as at least about 0.1 wt. %, such as at least about 0.5 wt. %, such as at least about 1.0 wt. % or even at least about 2 wt. %. Generally, concentrations of greater than about 10.0 wt. % are not necessary and may be detrimental by leaving excess residual carbon and nitrogen in the fine metal powder. In one particular characterization, the precursor powder includes at least about 3.0 wt. % and not greater than about 6.0 wt. % of the organic reductant. It has been found that the organic reductant may enable the production of fine metal powders of high purity at not greater than 1100° C., such as not greater than about 1000° C., or even not greater than about 850° C. Organic reductants such as HMTA are particularly useful for the refinement of SmCo magnetic powder.

In another implementation, the reductant comprises an alkaline earth metal hydride such as CaH₂ (calcium hydride) or MgH₂ (magnesium hydride). Using CaH₂ as an example, the alkaline metal earth metal hydride reductant reacts with the trace metal oxides to produce CaO and H₂. Using iron (II) oxide (FeO) as an example of the metal oxide, the reaction can be written as:

FeO+CaH₂=Fe+CaO+H₂ (1)

The CaH₂ dissociates at a relatively low temperature (<400° C.) to form Ca+H₂ and the Ca diffuses into the particles to react with the oxygen on the surface of the FeO. At the same time, H₂ (gas) must diffuse out, or the H₂ will react with free standing metal particles to form hydrides, which tend to lower the total magnetic energy or flux of the magnetic material (e.g., NdFeB). Therefore, efficient diffusion of H₂ through the particles is desired. There is no substantial diffusion limitation because the CaH₂—FeO or CaH₂—NdFeO mixture is not pelletized, and H₂ is able to escape from the reaction surface freely:

FeO+CaH₂→Fe+CaO+H_{2 (gas)} (2)

NdFeO+CaH₂→NdFe_{(alloy particles)}+CaO+H_{2 (gas)} (3)

NdO+CaH₂→CaO+Nd+H_{2 (gas)} (4)

The intermediate metal oxides (e.g., NdFeO₃, NdPrFeO, NdFeO, NdO, NdO₂ etc.) are reduced by CaH₂ rapidly in the solid state. This is the reason for contacting CaH₂ with the powder that has been partially or significantly reduced, in which oxygen exists as trace element or bulk element.

Removal of all traces of the reductant by-products (e.g., CaO) is important for the production of highly efficient magnets. The CaO particles are generally larger than the metal powders, so physical separation (e.g., screening) may be used for separation. Alternatively, or in addition, the CaO may be separated from the magnetic metal powder using gravity separation (e.g., in a centrifuge) due to that large difference in specific gravity between the CaO and the metal alloys. Finally, the by-product may be separated from the magnetic alloy powder using a magnetic field.

NdFeO is a common impurity in fine metal powders. It is too stable thermodynamically to be reduced by H₂ at low temperatures, e.g., temperatures less than about 1000° C., and higher temperatures, e.g., up to about 1300° C. may be required. This hardens the metals as soon as all oxygen is removed. The powder forms a solid block at that temperature when 100% of the oxygen is removed and the benefits of the powder are lost. CaH₂ can be used to reduce NdFeO at more moderate temperatures of from about 880° C. to 900° C., e.g., when held at that temperature for several hours. The final NdFe powder does not solidify at these temperatures and is free-flowing. Thermodynamically, little energy is required to use CaH₂ to reduce NdFeO as compared to Nd₂O₃. This is one reason why it is preferred to form the NdFeO, NdO, PrO, etc. before the reaction proceeds with a CaH₂ reductant.

The amount of metal hydride reductant added to the intermediate metal powder may be at least about 2.5 wt. %, such as at least about 5 wt. %. Typically, it will not be necessary or desirable to add more than about 20 wt. % of the metal hydride reductant to the intermediate metal powder. In one implementation, the amount of metal hydride reductant added to the intermediate metal powder is at least about 7 wt. % and is not greater than about 14 wt. %.

In addition to CaH₂, the metal hydride reductant may comprise other alkaline earth hydrides such as magnesium hydride (MgH₂), either alone or in combination with CaH₂. Further, alkaline earth fluoride compounds such as CaF₂ or MgF₂ may be utilized, although these compounds generate chlorine gas and may form a sludge that is difficult to manage.

In another implementation, calcium metal (e.g., elemental Ca granules or powder) or magnesium metal may be utilized as a reductant. In this implementation, the decomposition of CaH₂ is avoided by adding the calcium metal directly to the metal oxide powder, e.g., at a temperature of about 850° C. Further, the calcium metal will immediately melt and react with the metal oxides in a liquid-solid reaction.

In addition, it is preferred that the refining step include the application of pressure to the powder, e.g., the application of a pressure above ambient pressure for at least a portion of the refining step. For example, the applied pressure may be at least about 4 bar (0.4 MPa), such as at least about 5 bar (0.5 MPa), or even at least about 6 bar (0.6 MPa). Although there is not believed to be any theoretical upper limit on the applied pressure, practically the applied pressure will not greater than about 10 bar (1 MPa), such as not greater than about 9 bar (0.9 MPa). The pressure is applied as a gas pressure, e.g., in the absence of a substantial amount of mechanical (e.g., uniaxial) pressure. For example, the reactor (e.g., furnace) may be capable of maintaining a gas pressure above ambient during the compaction step. The pressurizing gas may be, for example, an inert (e.g., non-oxidizing) gas composition, for example comprised of nitrogen blended with a small amount of hydrogen and/or argon.

Although a magnetic field may be applied to the precursor powder during conversion to the metal, it is an advantage of this method that the heating step (e.g., to convert the precursor powder and crystallize the metal alloy particles) may be carried without the application of a magnetic field while still obtaining a compacted body that is aligned (e.g., oriented) with respect to the remnant magnetization.

The refined metallic powder or compacted magnetic body formed from the intermediate metallic powder may have a range of crystal structures, such as cubic, hexagonal and tetragonal. At increased temperatures (e.g., above the final precursor conversion temperature and the refining temperature) the individual metal crystals merge and coalesce to form multi-component metal crystals, e.g., crystalline metal alloys. As noted above, the individual metal crystals are believed to exhibit a preferred polarity direction due to different energy levels, e.g., different heat capacities of the metals. Thus, the metal powder (e.g., a collection of crystals) forms a magnetic field with a specific axis of orientation. In the case where a compacted magnetic body is formed, the temperature is increased and the individual metal crystals (particulates) coalesce to form the compacted magnetic body (e.g., a block) within a mold, e.g., where the compacted magnetic body takes the shape of the mold. It is generally preferred to maintain the refined powder at the compaction temperature for a time sufficient to ensure the formation and alignment of the magnetic metal crystals throughout the body.

The compacted body formed by the compaction step may be cooled and considered an end-product, e.g., a salable commodity, as the body is cohesive and has a relatively low porosity.

Alternatively, the compacted body may be further heated (e.g., sintered) to form a high-density, sintered magnetic body. In this regard, the compacted body may be heated to a sintering temperature above the compaction temperature for a period of time sufficient to densify the metal powder, e.g., to reduce porosity. For example, the sintering temperature may be greater than about 1000° C., such as at least about 1050° C. Generally, the sintering temperature should not exceed about 1350° C., such as not greater than about 1310° C. It is generally desirable to sinter the compacted magnetic body while avoiding the formation of a liquid phase.

FIG. 1 illustrates an example of a heating profile (time vs. temperature) that may be useful for the production of a sintered magnetic body of NdPrFeB according to the present disclosure, including a dehydration step. As illustrated in FIG. 1, heating cycle [A] includes first heating the precursor powder (e.g., disposed in a mold) to a dehydration temperature of about 280° C. and under a N₂/H₂ gas pressure of about 2.5 bar. After dehydration is completed, the precursor powder, now comprising anhydrous oxalate compounds, is subjected to sublimation and decomposition under N₂/H₂ gas, i.e., conversion of the oxalate compounds to the metals, through a series of heating steps. The temperature is increased to about 345° C. for a period of time of about 5 to 8 hours before the temperature is increased to about 640° C. and is held there for from about 5 to 8 hours under an N₂/H₂ gas. Thereafter, the temperature is increased sequentially to about 745° C. for from about 4 to 7 hours and then to about 845° C. for another 4 to 7 hours. Finally, the temperature is raised to about 885° C. and held for from about 8 to 10 hours to complete the conversion of the precursor powder (e.g., the metal oxalate compounds) to the elemental metals.

Heating cycle [A] therefore includes the dehydration of the hydrated metal oxalate precursor powder and the reduction of the dehydrated metal oxalates to metal alloy powder under a reducing N₂/H₂ gas composition containing about 22% H₂. The final product comprises an Fe-rich alloy phase (e.g., FePr and/or NdPrFe) and traces of an Nd-rich metal oxide phase (e.g., NdFeO, PrFeO and/or NdPrFeO). The total oxygen content of the powder is from about 1.97% to about 2.40%.

Upon substantial completion of the oxalate conversion to the elemental metals, a refining heating cycle [B] is used to form the compacted metal alloy particles, e.g., to remove residual oxygen, halides and/or carbon elements from the individual metal particulates. As illustrated in FIG. 1, the precursor powder is first cooled back to room temperature or near room temperature to facilitate introduction of a reductant to the metal powder, e.g., the addition of CaH₂. Thereafter, the metal powder is heated to a temperature of about 845° C. and held for from about 2 to 4 hours. The CaH₂ decomposes at about 643° C. and at about 816° C. the Ca melts to form a liquid phase. The increased pressure and temperature assist in the diffusion of the Ca metal into the particles (e.g., into the porosity) and facilitates the reaction with the metal oxides. Boron (added to the precursor as a metal) takes the place of the oxygen that is removed by the calcium. In this regard, the temperature is raised to about 910° C. and held for an additional 2 to 4 hours to ensure the reduction of NdFeO in the presence of the reductant, e.g., in the presence of Ca metal. These two heating steps are carried out under a pressure of from about 5 bar to 15 bar and a N₂/H₂ gas composition. Alternatively, a pure N₂ gas may be used as H₂ is a by-product of the CaH₂ reductant. The resulting high purity powder is substantially oxygen free and comprises free-flowing particles of NdFe, PrFe, NdPrFe, NdFeB, NdPrFeB, etc.

Thereafter, in heat cycle [C], the powder is cooled to facilitate removal of the reductant (e.g., the reductant by-products) from the magnetic powder. For example, the reductant by-products can be removed by dissolution, physical separation (e.g., sieving), magnetic separation or combinations thereof. In the case of CaO, the CaO may be selectively dissolved in ethylene glycol (e.g., mixed with deionized water) and decanted, followed by drying of the magnetic powder. Once the reductant by-products are removed from the magnetic metal alloy particles, the particles are heated to about 1100° C. and held for about 4 to 6 hours under a pressure of about 6.5 bar. The free-flowing particles may be milled (e.g., jet milled) at this stage if desired to maintain a desired particle size range. During the sintering step, the metal crystals will align in a preferred magnetic orientation, even in the absence of an applied magnetic field. This step results in a compacted magnetic body that may be cooled and provided to a manufacturer for sintering. The cooling of the sintered magnetic block may occur under a reduced pressure if desired to reduce the opportunity for oxides to form on the surface of the sintered block.

The sintering heating cycle [C] results in a sintered permanent magnetic block having very low porosity, e.g., a density of at least about 98%, at least about 99% or even at least about 99.5% or at least about 99.8% of the theoretical density. The sintered magnetic block may have a high magnetic remanence and a high magnetic coercivity, for example.

The compacted magnetic bodies may advantageously be fabricated into a variety of shapes, including round disks, square blocks, conical blocks, etc. The magnetic bodies may serve as a feedstock to facilities that produce permanent magnets. For example, the bodies may be machined to a required size/shape and subjected to magnetization under an electrically charged coil. The magnetized bodies may be surface coated to resist corrosion, e.g., using an epoxy or a corrosion-resistant metal.

FIG. 2 illustrates an example of a heating profile (time vs. temperature) that may be useful for the production of a sintered magnetic body according to the present disclosure where a reductant is not utilized and the refinement of the intermediate metal powder forms a compacted magnetic body. As illustrated in FIG. 2, the precursor powder is placed in a mold and undergoes a dehydration step at a temperature of from about 240° C. to about 280° C. and under a nitrogen/argon gas pressure of from about 1.0 bar (e.g., atmospheric) to about 2.5 bar. After dehydration is completed, the precursor powder, now comprising anhydrous oxalate compounds, is subjected to sublimation and decomposition under hydrogen gas, i.e., conversion of the oxalate compounds to the metals. In this step, the temperature is increased to from about 340° C. to about 380° C. for a period of time before being increased to from about 400° C. to about 645° C. The atmosphere is a mixture of nitrogen and hydrogen, where nitrogen can be replaced by any inert gas, at a gas pressure of from about 2.5 bar to about 3.0 bar.

Upon substantial completion of the oxalate conversion to the elemental metals, a refining step is used to form the metal alloy particles, e.g., to remove lingering residual oxygen, halides and/or carbon elements from the individual metal particulates. In this regard, the precursor powder is heated to a temperature of from about 700° C. to about 945° C. for a period of time under a gas pressure of from about 3.0 bar to about 4.0 bar. Thereafter, the temperature is increased to from about 980° C. to about 1035° C. for a period of time under a gas pressure of from about 4.0 bar to about 4.5 bar.

Once the metal alloy particles are formed, metal crystals are developed (e.g., crystallization) by increasing the temperature to from about 1085° C. to about 1130° C. and the gas pressure is increased to from about 4.5 bar to about 6.5 bar. During this step, the metal crystals will align in a preferred orientation, even in the absence of an applied (e.g., artificially applied) magnetic field. This step results in a compacted magnetic body that may be cooled and provided to a manufacturer for sintering.

As illustrated in FIG. 2, the compacted magnetic body from the crystallization step, with well-aligned crystals, is further heated to sinter the compacted magnetic body and form a sintered magnetic material. In this regard, the temperature is increased to from about 1130° C. to about 1310° C. under a gas pressure of not greater than about 6.5 bar. During the sintering step, an external magnetic field may be applied to the compacted magnetic body, e.g., to accentuate the easy magnetic axis formed during the refining and crystallization steps. By definition, the sintering step causes individual metal crystals to coalesce into compact grains which leads to a reduction in porosity and increased density. The sintering step may be controlled (e.g., temperature, pressure, duration) to substantially avoid the formation of a liquid phase, e.g., so that the sintering occurs in the solid phase. Stated another way, the sintering step is carried out by avoiding the liquidus phase in the phase diagram for the metal alloy. Thereafter, the sintered magnetic material is cooled under a vacuum, e.g., from about 100 torr (0.13 bar) to about 400 torr (0.53 bar).

The sintering step results in a sintered permanent magnetic block having very low porosity, e.g., a density of at least about 98%, at least about 99% or even at least about 99.5% or at least about 99.8% of the theoretical density. The sintered magnetic block may have a high magnetic remanence and a high magnetic coercivity, for example.

It will be appreciated that the heating profiles illustrated in FIG. 1 and FIG. 2 are merely an example of two heating profiles and are not intended to be limiting. Further, one of skill in the art will realize that although the various heating steps shown in FIG. 1 and FIG. 2 are labeled as encompassing certain chemical and physical transformations to the precursor powder (e.g., oxalate sublimation, refining, crystallization, etc.), the actual transformations may overlap the illustrated temperature and pressure conditions.

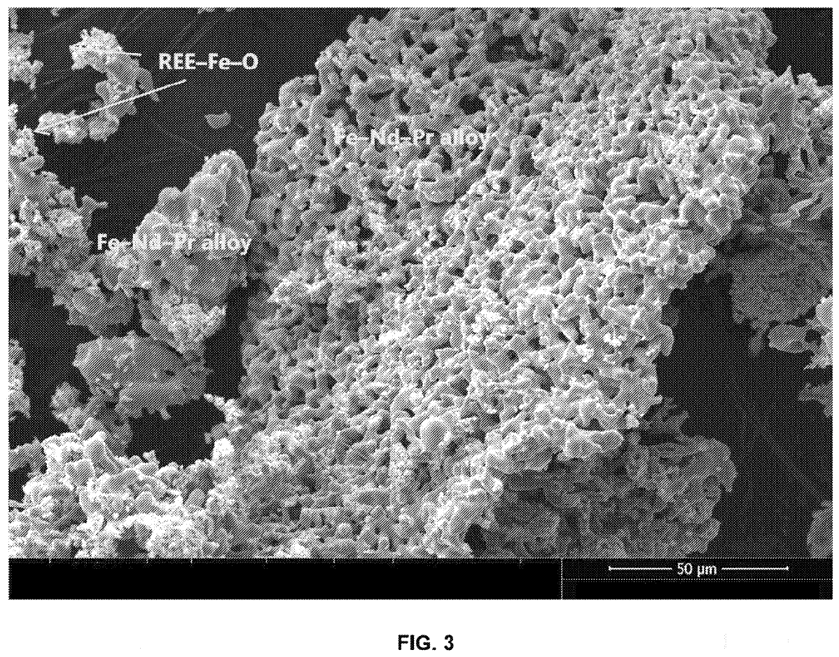

FIG. 3 is an SEM photomicrograph illustrating an example of two phases that appear after decomposition of a precursor powder containing metal carboxylate salts of Fe₂C₂O₄, Nd₂(C₂O₄)₃ and Pr₂(C₂O₄)₃ to form the intermediate powder. The Fe-rich phase (NdPrFe) forms the bulk of the powder with traces of Nd-rich oxide (NdPrFeO) at the surface of the crystals. The concentration of oxygen in the intermediate powder may be measured by LECO analysis, e.g., using infrared absorption and thermal conductivity measurements. As stated above, this powder with traces of oxidized alloys may be treated with a reductant such as CaH₂ to reduce the trace oxide to metallic NdPrFe.

Although the foregoing description relates to methods for the production of magnetic materials, the methods are also applicable to certain non-magnetic metal alloys. In one example, the titanium alloy Ti64 (Ti+6% Al+4% V) may be produced using the foregoing methods. In this example, the precursor powder may include ammonium metal oxalates of titanium, vanadium and aluminum and a reductant such as HTMA may be used as a reductant, as is discussed above. The use of HTMA advantageously eliminates the need to remove reductant by-products from the final powder.

### EXAMPLES

### Example 1

In this Example 1, a precursor powder having the following composition is placed in a mold:

TABLE II

| | | Weight |
|---|---|---|
| Metal | Compound/Metal | (grams) |
| Iron | Iron Oxalate | 60.00 |
| Aluminum | Aluminum Metal | 0.04 |
| Boron | Boron Metal | 0.29 |
| Neodymium | Neodymium Oxalate | 17.00 |
| Praseodymium | Praseodymium Oxalate | 6.15 |
| Cobalt | Cobalt Oxalate | 0.95 |
| Copper | Copper Oxalate | 0.12 |
| Gallium | Gallium Oxide | 0.09 |

The precursor powder is heated to a dehydration temperature of from about 240° C. to 280° C. under a flow of substantially pure nitrogen gas for from about 6 to 12 hours. After dehydration, the precursor powder is heated stepwise to a temperature of about 885° C. under a gas pressure of about 5 bar for at least about 8 hours to form an alloyed metal powder comprising about 95 wt. % to 97 wt. % NdPrFe (Fe-rich) and from about 3 wt. % to about 4 wt. % NdPrFeO (Nd-rich). After cooling, CaH₂ powder is added in a stoichiometric amount and the sample is reheated to about 910° C. and is held for at least 5 hours. After cooling, CaO is separated from the NdPrFeB crystals. The NdPrFe crystals are then heated to about 1100° C. under a pressure of about 6.5 bar. After cooling, the compacted magnetic body comprises anisotropic metal crystals (e.g., tetrahedral crystals) of an NdPrFeB magnetic material. The magnetic material is characterized by well aligned single crystals of a magnetic NdPrFeB alloy. Elemental analysis shows that the material comprises about 0.07 wt. % carbon, less than about 0.5 wt. % hydrogen, about 0.01 wt. % nitrogen, about 0.26 wt. % oxygen and less than about 0.01 wt. % sulfur. Oxygen content is measured from a small metal chip cut from the block and determining the atomic mass per unit area in the chip. Oxygen content can also be estimated using energy-dispersive X-ray spectroscopy (EDS) for example.

### Example 2

In this Example 2, a precursor powder having the following composition is placed in a mold:

TABLE III

| | | Weight |
|---|---|---|
| Metal | Compound/Metal | (grams) |
| Iron | Iron Oxalate | 112.75 |
| Aluminum | Aluminum Metal | 0.7 |
| Titanium | Titanium Oxalate | 5.0 |
| Nickel | Nickel Oxalate | 43.59 |
| Cobalt | Cobalt Oxalate | 108.67 |
| Copper | Copper Oxalate | 11.81 |

The precursor powder is heated to a dehydration temperature of from about 240° C. to 280° C. under a flow of substantially pure nitrogen gas for from about 6 to 12 hours. After dehydration, the precursor powder is heated stepwise to a final temperature of about 1100° C. under a gas pressure of about 5 bar to form the compacted magnetic body comprising aligned metal crystals of an AlNiCo magnetic material. Elemental analysis shows that the material comprises less than about 0.05 wt. % carbon, less than about 0.5 wt. % hydrogen, about 0.01 wt. % nitrogen, about 0.14 wt. % oxygen and less than about 0.01 wt. % sulfur.

### Example 3

In this Example 3, a precursor powder having the following composition is placed in a mold:

TABLE IV

| | | Weight |
|---|---|---|
| Metal | Compound/Metal | (grams) |
| Cobalt | Cobalt Oxalate | 32.21 |
| Samarium | Samarium Oxalate | 42.42 |
| Copper | Copper Oxalate | 14.76 |
| Hafnium | Hafnium Metal | 2.0 |
| Iron | Iron Oxalate | 57.99 |

The precursor powder is heated to a dehydration temperature of from about 240° C. to 280° C. under a flow of substantially pure nitrogen gas for from about 6 to 12 hours. After dehydration, the precursor powder is heated stepwise to a final temperature of about 1130° C. under a gas pressure of about 5 bar to form the compacted magnetic body comprising aligned metal crystals of a Sm₂Co₁₇ magnetic material. Elemental analysis shows that the material comprises less than about 0.05 wt. % carbon, less than about 0.5 wt. % hydrogen, about 0.01 wt. % nitrogen, less than about 0.1 wt. % oxygen and about 0.01 wt. % sulfur.

### Example 4

Two samarium cobalt magnetic alloy powders are produced in accordance with the present disclosure. A first alloy is Sm₂Co₇ and a second alloy is SmCo₇. In this example, HMTA is added as a reductant to the SmCo powder after the formation of the intermediate powder (see FIG. 1) at a concentration of from about 0.5 wt. % to about 1 wt. %. The compositional analysis of the alloy powders is listed in Table V.

TABLE V
Samarium Cobalt Alloy Powders, 1-5 microns (90% passing)

| Element | Unit | SmCo (2:7) | SmCo (1:7) |
|---|---|---|---|
| C | % w/w | 0.11 | 0.04 |
| H | % w/w | <0.5 | <0.5 |
| N | % w/w | <0.01 | <0.01 |
| \hat{ }O | % w/w | 0.59 | 0.64 |
| S | % w/w | 0.04 | 0.01 |
| La | % w/w | <0.005 | <0.003 |
| Ca | % w/w | <0.01 | <0.01 |
| Nd | % w/w | <0.01 | <0.01 |
| Pr | % w/w | <0.01 | <0.01 |
| Y | % w/w | <0.001 | <0.001 |
| Sm | % w/w | 21.1 | 10.49 |
| Ni | % w/w | 0.008 | 0.011 |
| Co | % w/w | 45.1 | 57.6 |
| Fe | % w/w | 14.9 | 25.5 |
| K | % w/w | <0.006 | <0.006 |
| Na | % w/w | <0.002 | <0.002 |
| Ca | % w/w | 0.0024 | 0.0022 |
| Mg | % w/w | 0.009 | 0.007 |
| Mn | % w/w | 0.0270 | 0.0449 |
| Al | % w/w | <0.004 | <0.004 |
| Hf | % w/w | 1.48 | 0.99 |
| Cu | % w/w | 16.6 | 4.65 |
| Total | | 99.99 | 99.99 |

* O₂ was analyzed directy in the micropowders by LECO methods
* Powders are subsequently purged at proprietary conditions to achieve <0.1% O in sintered metal alloys

The samarium cobalt alloy magnetic powder has a high purity and a narrow size distribution with 90% of the particles having a size of less than 5 μm. Increasing the HTMA to about 1.5 wt. % is anticipated to remove all traces of oxygen.

### Example 5

Table VI illustrates the analysis of a refined NdFeB magnetic alloy powder produced in accordance with the present disclosure.

TABLE VI
NdFeB Alloy Powder

| Element | Unit | Assay |
|---|---|---|
| Carbon | % w/w | <0.05 |
| Hydrogen | % w/w | <0.5 |
| Nitrogen | % w/w | <0.01 |
| Oxygen | % w/w | <0.1 |
| Sulfur | % w/w | 0.01 |
| Lanthanum | % w/w | <0.002 |
| Cerium | % w/w | 0.05 |
| Neodymium | % w/w | 30.00 |
| Dysprosium | % w/w | 0.20 |
| Boron | % w/w | 0.90 |
| Nickel | 9% w/w | 0.01 |
| Cobalt | % w/w | 0.36 |
| Copper | % w/w | <0.001 |
| Aluminum | % w/w | 0.08 |
| Hafnium | % w/w | <0.005 |
| Gallium | % w/w | <0.01 |
| Iron | 2% w/w | 68.30 |
| Potassium | % w/w | <0.006 |
| Sodium | % w/w | <0.002 |
| Calcium | % w/w | 0.01 |
| Magnesium | 1% w/w | <0.0001 |
| Manganese | % w/w | 0.01 |
| Praseodymium | % w/w | 0.02 |
| Titanium | % w/w | NR |
| NdFeB | Purity % wt. | 99.96 |

In this example, CaH₂ reductant is used to remove substantially all traces of oxygen from the intermediate powder.

While various embodiments of a method for the production of compacted magnetic materials and sintered magnetic materials, have been described in detail, it is apparent that modifications and adaptations of those embodiments will occur to those skilled in the art. However, is to be expressly understood that such modifications and adaptations are within the spirit and scope of the present invention.

What is claimed is:

1. A method for producing a compacted magnetic body, comprising the steps of:
providing a precursor powder to a furnace, the precursor powder comprising particulates of at least a first metallic compound and having a mean average particle size of not greater than about 100 μm; and
heating the precursor powder within the furnace to a precursor conversion temperature that is sufficient to convert the first metallic compound to a first metal and form a metallic powder comprising particulates of the first metal,
wherein the step of heating the precursor powder is carried out under a compacting gas pressure of at least about 2 bar to form a compacted magnetic body.

2. The method recited in claim 1, wherein the first metallic compound comprises a first metal oxalate compound.

3. The method recited in claim 2, wherein the first metal oxalate compound is a first rare earth oxalate compound.

4. The method recited in any one of claims 1 to 3, wherein the precursor powder comprises particulates of at least a second metallic compound.

5. The method recited in claim 4, wherein the second metallic compound comprises a second metal oxalate compound.

6. The method recited in claim 5, wherein the second metal oxalate compound is a second rare earth oxalate compound.

7. The method recited in claim 6, wherein the first rare earth oxalate compound is neodymium oxalate.

8. The method recited in claim 7, wherein the second metal oxalate compound is praseodymium oxalate.

9. The method recited in claim 8, wherein the precursor powder further comprises particulates of iron oxalate.

10. The method recited in claim 9, wherein the precursor powder further comprises particulates of metallic boron.

11. The method recited in claim 3, wherein the first rare earth metal oxalate compound is samarium oxalate and wherein the precursor powder further comprises a particulate cobalt-containing compound.

12. The method recited in claim 11, wherein the cobalt-containing compound is cobalt oxalate.

13. The method recited in claim 2, wherein the first metal oxalate compound is iron oxalate.

14. The method recited in claim 13, wherein the precursor powder further comprises particulates of nickel oxalate and particulates of cobalt oxalate.

15. The method recited in claim 14, wherein the precursor powder further comprises particulates of metallic aluminum.

16. The method recited in claim 15, wherein the precursor powder further comprises particulates of ammonium titanium oxalate or titanium metal, and particulates of copper oxalate.

17. The method recited in any one of claims 1 to 16, wherein the precursor powder comprises not greater than about 2.5 wt. % free carbon.

18. The method recited in claim 17, wherein the precursor powder comprises not greater than about 1.5 wt. % free carbon.

19. The method recited in claim 17, wherein the precursor powder comprises not greater than about 0.5 wt. % free carbon.

20. The method recited in any one of claims 1 to 19, wherein the precursor powder has a mean average particulate size of not greater than about 50 μm.

21. The method recited in claim 20, wherein the precursor powder has a mean average particulate size of not greater than about 20 μm.

22. The method recited in claim 20, wherein the precursor powder has a mean average particulate size of not greater than about 10 μm.

23. The method recited in any one of claims 1 to 22, wherein the precursor powder has a mean average particulate size of not greater than about 5 μm.

24. The method recited in claim 23, wherein the precursor powder has a mean average particulate size of at least about 0.5 μm.

25. The method recited in any one of claims 2 to 24, wherein at least the first metal oxalate compound is a hydrated metal oxalate compound.

26. The method recited in claim 25, wherein the heating step comprises heating the precursor powder to a dehydration temperature of not greater than about 280° C. for a period of time sufficient to remove at least 90% of water of hydration from the hydrated metal oxalate compound.

27. The method recited in claim 26, wherein dehydration temperature is at least about 240° C.

28. The method recited in any one of claims 26 to 27, wherein the period of time is sufficient to remove at least about 95% of the water of hydration from the hydrated metal oxalate compound.

29. The method recited in claim 28, wherein the period of time is sufficient to remove at least about 98% of the water of hydration from the hydrated metal oxalate compound.

30. The method recited in any one of claims 25 to 29, comprising the step of moving a sweep gas past the precursor powder to carry released water of hydration away from the first metal oxalate compound.

31. The method recited in claim 30, wherein the sweep gas comprises nitrogen.

32. The method recited in claim 31, wherein the sweep gas comprises at least about 98% nitrogen.

33. The method recited in any of claims 25 to 32, wherein the pressure over the mold during the step of heating to a dehydration temperature is not greater than about 2.5 bar.

34. The method recited in any one of claims 1 to 33, wherein the precursor conversion temperature is at least about 980° C.

35. The method recited in claim 34, wherein the precursor conversion temperature is at least about 1000° C.

36. The method recited in claim 34, wherein the precursor conversion temperature is at least about 1085° C.

37. The method recited in any one of claims 1 to 36, wherein the step of heating the precursor powder comprises heating under a non-oxidizing gas composition.

38. The method recited in claim 37, wherein the non-oxidizing gas composition comprises at least about 95% of nitrogen and hydrogen combined.

39. The method recited in claim 37, wherein the non-oxidizing gas composition comprises at least about 98% of nitrogen and hydrogen combined.

40. The method recited in any one of claims 1 to 39, wherein the compacting gas pressure is at least about 4 bar.

41. The method recited in claim 40, wherein the compacting gas pressure is at least about 5 bar.

42. The method recited in claim 40, wherein the compacting gas pressure is at least about 6 bar.

43. The method recited in any one of claims 1 to 42, wherein the heating step is carried out in the absence of an applied magnetic field.

44. The method recited in any one of claims 1 to 43, wherein the mold is formed from a ceramic material.

45. The method recited in claim 44, wherein the ceramic material is alumina.

46. A compacted magnetic body formed by a method recited in any one of claims 1 to 45.

47. A method for producing a sintered magnetic body, comprising the step of sintering a compacted magnetic body as recited in claim 46.

48. The method recited in claim 47, wherein the sintering step comprises heating the compacted magnetic body to a temperature of at least about 1130° C.

49. The method recited in any one of claim 47 or 48, wherein the sintering step comprises heating the compacted magnetic body to a temperature of not greater than about 1350° C.

50. The method recited in any one of claims 47 to 49, wherein the sintering step is carried out under a gas pressure of not greater than about 6.5 bar.

51. A sintered magnetic body formed by a method recited in any one of claims 47 to 50.

52. A sintered magnetic body as recited in claim 51, wherein the sintered magnetic body is diametrically magnetized.

53. The sintered magnetic body recited in any one of claims 51 to 52, wherein the sintered magnetic body is substantially in the form of a disc.

54. The sintered magnetic body recited in any one of claims 51 to 52, wherein the sintered magnetic body is substantially in the form of a ring.

55. The sintered magnetic body recited in any one of claims 51 to 52, wherein the sintered magnetic body is substantially in the form of a cone.

56. The sintered magnetic body recited in any one of claims 51 to 52, wherein the sintered magnetic body is in the form of a cube.

57. A method for the production of a magnetic alloy powder, comprising the steps of:
providing a precursor powder to a furnace, the precursor powder comprising particulates of at least first and second metal carboxylate compounds;
heating the precursor powder within the furnace under a first elevated pressure to a precursor conversion temperature that is sufficient to convert the first and second metal carboxylate compounds to a first metal alloy and form an intermediate metallic powder comprising particulates of the first metal alloy;
adding a reductant to the intermediate metallic powder;
heating the intermediate metallic powder and the reductant to a refining temperature that is sufficient for the reductant to react with residual oxygen in the intermediate metallic powder to form a magnetic alloy powder and a reductant by-product; and
separating the magnetic alloy powder from the reductant by-product.

58. The method recited in claim 57, wherein the precursor powder has a mean average particle size of not greater than about 100 μm.

59. The method recited in any one of claim 57 or 58, wherein the at least first and second metal carboxylate compounds are metal oxalate compounds.

60. The method recited in any one of claims 57 to 59, wherein the first elevated pressure is at least about 2.5 bar (0.25 MPa).

61. The method recited in any one of claims 57 to 60, wherein the precursor conversion temperature is at least about 800° C.

62. The method recited in any one of claims 57 to 61, wherein the reductant is selected from the group consisting of CaH₂, MgH₂, elemental Ca, elemental Mg and combinations thereof.

63. The method recited in claim 62, wherein the reductant comprises CaH₂.
